(19) United States
(12) Patent Application Publication
(10) Pub. No.: US 2010/0114338 A1
(43) Pub. Date: May 6, 2010

(54) MULTI-GOAL PATH PLANNING OF WELDING ROBOTS WITH AUTOMATIC SEQUENCING

(75) Inventors: SANDIPAN BANDYOPADHYAY, CHENNAI (IN); ASHISH GUPTA, BANGALORE (IN)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/262,918

(22) Filed: Oct. 31, 2008

(51) Int. Cl. G05B 13/02; B25J 9/06

(52) U.S. Cl. 700/36; 700/33; 901/16; 901/42

(57) ABSTRACT

A system and method for multi-goal path planning of welding robots with automatic sequencing. Input parameters associated with a number of goal points are obtained. The robot is moved through the multiple goal points based on the obtained inputs. One or more allowed cyclic paths are identified based on the obtained inputs. Weights are assigned to pre-defined attributes for path segments for each of the allowed cyclic paths. A cumulative score based on the values and assigned weights of the pre-defined attributes is calculated. An optimal path for the movement of robot across the goal points is identified based on the cumulative score.

### BACKGROUND OF THE INVENTION

1. Field of the Invention

This invention relates generally to a system and method for providing multi-goal path planning for a robot and, more particularly, to a system and method for providing multi-goal path planning for a welding robot that identifies an optimum path based on an accumulative score for each allowed cycle path of the robot.

2. Discussion of the Related Art

In applications where robots are used in automotive manufacturing processes, particularly in the case of automotive body in white (BIW) design, a welding robot may be used that has to move through multiple weld points where a welding operation has to be performed with specified orientations. In some cases, the path of the robot includes points that are not weld points, but are inserted manually or by software to avoid interference with obstacles, such as parts, fixtures and tools, from movement of the robot.

Path planning of the welding robots is a key step in the automotive BIW manufacturing process design. The generation and validation of the robot path is essentially a manual process assisted by robot simulation software. Existing commercial tools have the capability to generate point-to-point (PTP) collision-free paths between two sets of user-specified positions and orientation pairs. However, for welding applications, the path is a multi-goal path, meaning that the robot has to reach a number of weld-points in a single cycle. There are practical instances where the goals are non-continuous, i.e., obstacles separate the welds. In such cases, the sequence of welds to be reached by the robot has to be turned manually and in addition to the natural weld points, new via points may need to be introduced. The path thus generated has to be validated for interference, and also to meet cycle time constraints. However, the planned path may not meet these conditions the first time, and hence the entire operation needs to be modified and revalidated. Therefore, the existing process involves manual iterations having a number of drawbacks including that the process is time consuming and interactive, the quality of results depend on the skill and experience of the user of the simulation tools, and the results meet only feasibility requirements in that they are not optimal in general.

An algorithmic solution to this problem has been proposed by combining the PTP path planning problem with an optimal sequencing problem. However, this solution does not consider the problems that can occur due to the robot reaching and passing through singular configurations, and therefore, the solution may lead to uncontrollable robot paths.

Further, existing systems use software for the computation of point to point (PTP) paths for collision-free movement of the robot. Actual cases require the robot to move via several goal points rather than separate PTP segments. Goal points include weld points Where welding has to be performed and intermediate points, where welding is not done, but that help in optimizing the path of the robot. Therefore, to traverse a complete path comprising multiple weld and intermediate points, continuous inputs to the robot simulation software are required to plan the movement of the robot.

### SUMMARY OF THE INVENTION

In accordance with the teachings of the present invention, a system and method are disclosed for multi-goal path planning for a robot. Input parameters associated with several goal points are obtained. The robot is moved through multiple goal points based on the obtained inputs. One or more allowed cyclic paths are identified based on the obtained inputs. Weights are assigned to pre-defined attributes for path segments for each of the allowed cyclic paths. A cumulative score based on the values and assigned weights of the pre-defined attributes is calculated. An optimal path for the movement of the robot through the goal points is identified based on the cumulative score.

Additional features of the present invention will become apparent from the following description and appended claims, taken in conjunction with the accompanying drawings.

### BRIEF DESCRIPTION OF THE DRAWINGS

FIG. 1 illustrates a three-dimensional view of a wire frame model of a sample part showing multiple weld points marked on the part;

FIG. 2 is a simple plan view of a robot including a weld gun;

FIGS. 3, 4, 5 and 6 show some of the possible cyclic paths through which the movement of the robot can take place; and

FIG. 7 is a flow diagram illustrating a method for multi-goal path planning for a robot.

### DETAILED DESCRIPTION OF THE EMBODIMENTS

The following discussion of the embodiments of the invention directed to a system and method for proving multi-goal path planning for welding robots is merely exemplarary in nature, and is in no way intended to limit the invention or its application or uses.

The present invention proposes a multi-goal optimal path-planning algorithm for a welding robot that takes the same geometric inputs, such as the goal configurations, i.e., weld points and gun orientation at weld points, geometry of the parts and fixtures, etc., and generates a collision free path that automatically determines the optimal sequence of welds based on a certain cost function associated with the entire path. The cost can include one or more of cycle time, smoothness criterion of the path and total joint motion of the robot. The algorithm would branch over all the possible configurations generated by inverse kinematics separately, and would therefore be free of singularities. The algorithm would also eliminate the costly manual iterations, and provide fast, smooth and collision-free paths.

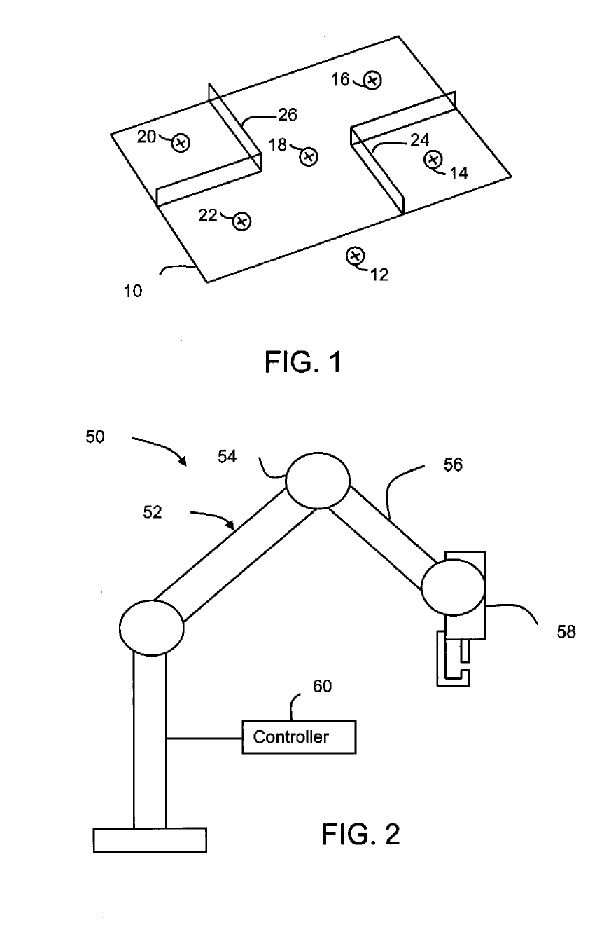

FIG. 1 illustrates a three-dimensional wire-frame model of a sample part 10 showing a home position 12 and multiple weld points 14, 16, 18, 20 and 22 marked on the part 10. A welding robot, discussed below, would move from the home position 12 to each of the weld points 14-22 in some predetermined sequence to perform the welding operations on the part 10. Although the discussion herein is specific to a welding robot performing welding operations, the path planning of the invention will have application for other robots performing other operations besides welding.

FIG. 2 is a simple plan view of a typical six axis robot 50 suitable for the purposes described herein. The robot 50 includes robotic arms 52 and joints 54 that allow the robot 50 to move to the desired location on the part 10. The robot 50 includes a weld gun 56 that allows the robot 50 to weld the part 10 at the welds point 14, 16, 18, 20 and 22. The robot home position 12 represents the default or idle state of the robot 50. Every operation starts from the home position 12, and once all the points 14-22 have been covered, the robot 50 returns to the home position 12. Although the discussion herein refers to the part 10 including the weld points 14-22, other types of robots may perform other operations on the part 10 other than welding where the weld points 14-22 will be other types of points, commonly referred to as goal points. For the discussion below, the weld points 14-22 are intended to represent any type of goal point on the part 10 or any other part. A controller 58 controls the operation of the robot 50 and performs the various operations and functions described below for that application.

The weld points 14-22 are distributed across the sample part 10 with some of the points bordered or surrounded by wall-like fixtures 24 and 26. The robotic arms 52 of the welding robot 50 have to cover all of the points 12-22 to perform the welding operations. In this process, the robotic arms 52 also have to move over the fixtures 24 and 26 to reach certain of the points 12-22. The robot 50 moves from one point to the other based on certain input parameters. The input parameters include, but are not limited to, details related to the geometry of the part 10, such as positional parameters of the weld points, the height of the obstacle, etc., or the configuration details of the robot 50 at the weld points 14-22, such as gun orientation at the weld points 14-22.

The robot 50 can follow a number of possible paths to cover all of the weld points 14-22. The choice of path taken depends upon a set of pre-defined attributes that are characteristic of the movement of the robot 50. For example, these pre-defined attributes include, but are not limited to, the time taken to cover a path segment, the load experienced by the joints 54 of the robot 50 during the movement, the smoothness criterion of the entire path, etc. The movement of the robotic arms 52 across the weld points 14-22 generates different values of pre-defined attributes across path segments for the different paths. For example, the load on the robotic joints 54 may differ from one path to another where the sequence of covering the weld points 14-22 is different. The importance of a particular pre-defined attribute for a particular path can be represented by assigning weights to the pre-defined attributes. The combination of the values of the pre-defined attributes and assigned weights to the pre-defined attributes is used to calculate a cumulative score for a particular path. Based on the factor or factors that need to be optimized during an operation involving the robot 50, an optimal path is selected. This is achieved by choosing a path that gives the minimum cumulative score with respect to the pre-defined attributes, which need to be optimized.

When the points 14-22 are in one plane without any obstructions to separate them, the robotic joints 54 do not undergo much load variation. However, if the robot 50 has to move over obstacles, the joints 54 have to be oriented accordingly, and once the operation has been performed, they are returned to the default orientation. Repeated change in the configuration of the robotic joints 54 results in load cycles over a short period and adds to the overall wear of the robot 50.

The change in the orientation of the robotic joints 54 from one configuration to another may also lead to a situation where the instantaneous load value on a joint theoretically approaches infinity. Such a configuration change is termed a singularity and is not allowed. A path where a singularity occurs is not considered while choosing an optimal path for the robot as the configuration states that the robot passes through in such a case are not allowed. The load values of the robotic joints 54 are obtained by using inverse kinematics.

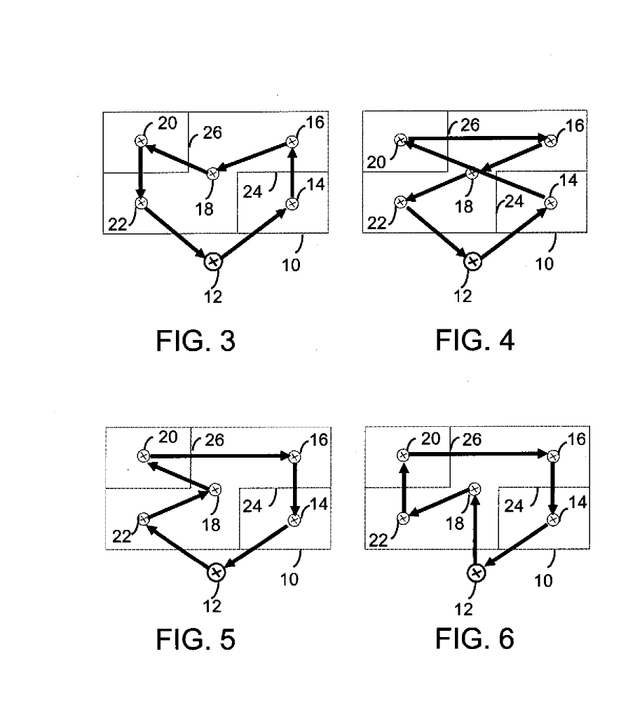

FIGS. 3, 4, 5 and 6 show exemplary cyclic paths through which the robot movement, as manifested by the movement of the robotic arms 52, can take to perform the same operation. The points 14-22 can be covered in a number of cyclic paths. FIG. 3 shows such a path, termed as a path segment, where the robot 50 moves from one point to another in a straightforward sequence 12→14→16→18→20→22. In this path, the robot 50 has to move over the fixtures 24 and 26 on the sample part 10 three times. A fewer number of movements over the fixtures 24 and 26 can be achieved if a different path, such as 12→14→20→16→18→22, is chosen, as shown in FIG. 4.

FIGS. 5 and 6 represent other possible paths, particularly 12→22→18→20→16→14 and 12→18→22→20→16→14, respectively, through which the robot 50 can be moved, each denoting a cyclic path, which is optimal with respect to a particular pre-defined attribute.

As mentioned above, the selection of an optimal robot path depends on a set of pre-defined attributes, and is a direct function of these attributes. These factors include attributes such as the total cost value, total load experienced on the robotic joints 54, total time for the movement of the robot 50 in a cyclic path, smoothness criterion etc. The weight assigned to a particular pre-defined attribute during a cyclic path is also one of the pre-defined attributes. The weights assigned to a parameter and value of the parameter is used to calculate a cumulative score for an allowed cyclic path. The cumulative score is an indication of the attributes or a set of attributes that needs to be minimized over a cyclic path. For example, if the total joint load value needs to be minimized for a particular path, then the weight attached to the joint load value for each segment of the cyclic path is higher than the weight assigned to the rest of the attributes. The score for each path segment of the cyclic path is obtained by combining the value of each pre-defined attribute and the assigned weights to the attributes. The cumulative scores for each allowed cyclic path is calculated by summing up the score for each path-segment, and the path with the minimum cumulative score is the optimal path with respect to the cycle time. Similar scores can be obtained for other attributes and even for a set of attributes. Again, based on the scores, an optimal path can be selected.

Optimization of the multi-goal path for the robot 50 is performed with the help of algorithms and mathematical analyses. The movement of the joints 54, the arms 52 and the detection of singularities can be done with the help of the robot's DH parameters and inverse kinematics. The joint load values for each configuration can also be estimated using dynamic analysis and joint limits of the robot 50. For each of the allowed configurations obtained from the inverse kinematic calculations, cyclic paths covering all of the weld points 14-22 are constructed. The construction of such paths can be broken down into point-to-point (PTP) movements by using a probabilistic road map (PRM) and rapidly growing random tree (RRT) based path planners. When an entire path has been obtained, the robot 50 moves through all of the weld points. The sequence in which the points 14-22 need to be covered is decided by the cumulative score with respect to one or more pre-defined attributes, as described earlier.

In some cases, intermediate points where welding is not performed may be introduced on the work surface to achieve a path with the minimum value of a particular parameter. For example, when the robot 50 moves over obstacles, it switches configurations, thereby increasing the load on the robotic joints 54. If an intermediate point chosen so that the robot 50 continues in the same configuration to reach the target point via the intermediate point, the total load parameter can be minimized for the cyclic path. Such a path may increase the total distance travelled or the total cycle time for the process, however, the path chosen will be optimal with respect to the total load on the joints 54.

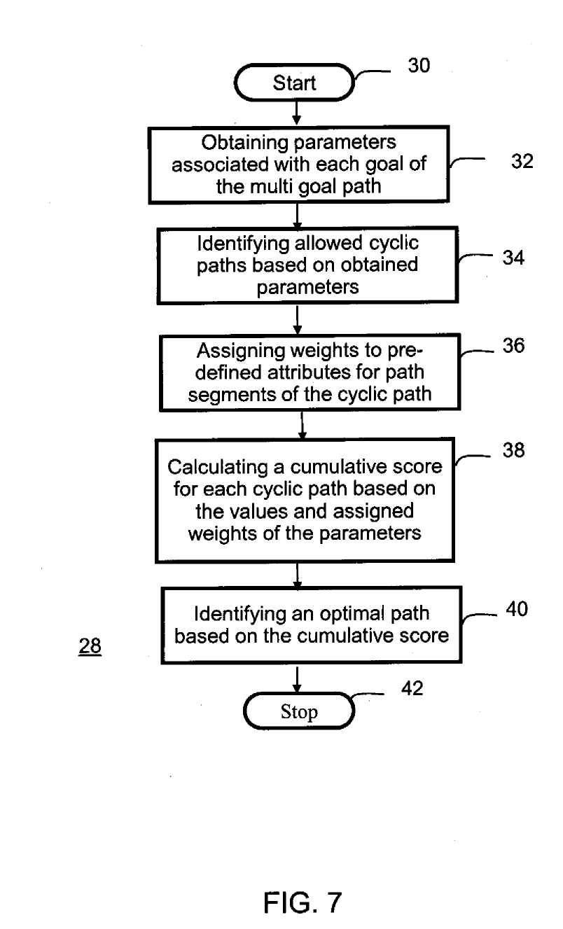

FIG. 7 is a flow diagram illustrating a method 28 for multi-goal path planning of a robot. The method starts at step 30. At step 32, the input parameters associated with the multiple goal points of the robot 50 are obtained. The parameters include geometric inputs (co-ordinates of the goal points) and goal configurations (weld gun orientation at the weld points) The allowed cyclic paths, based on the parameters obtained, are identified at step 34. The identification of allowed cyclic paths is done with the help of inverse kinematics, which calculates load values at robotic joints 54 in every configuration. In case the load value at any of the joints 54 approaches infinity theoretically in a configuration, such a path is not allowed. These configurations are termed as singularities. At step 36, weights are assigned to the pre-defined attributes for each segment of a cyclic path. At step 38, a cumulative score based on the assigned weights of the pre-defined attributes and the values of these attributes over a cyclic path. At step 40, an optimal path is identified based on the cumulative score. The method is terminated at step 42.

Various embodiments of the present invention offer one or more advantages. The present invention provides a system and method for multi-goal path planning of welding robots with automatic sequencing. The invention results in reduction in total cycle time by eliminating tedious manual iterations, thereby improving the productivity. Further, the process is automated and a faster determination of the weld sequence along with corresponding smooth path planning takes place. This translates into increased efficiency of the body-in-white (BIW) process and layout engineering. Additionally, the process determines the optimal solution rather than just a feasible attainable by computer simulation. This eliminates re-work by activities such as robot programming and control. Furthermore, a complete elimination of human intervention is achieved, which reduces engineering costs.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for multi-goal path planning for a robot, said method comprising:
obtaining parameters associated with each goal of the multi-goal path;
identifying one or more allowed cyclic paths based on the obtained parameters;
assigning weights to pre-defined attributes for path segments of each of the one or more allowed cyclic paths;
calculating a cumulative score for each allowed cyclic path based on the assigned weights and values of the pre-defined attributes; and
identifying an optimal path based on the cumulative score.

2. The method according to claim 1 wherein the robot is a welding robot.

3. The method according to claim 2 wherein the welding robot is used in automotive manufacturing process for welding a body in white.

4. The method according to claim 1 wherein the goal points are welding points.

5. The method according to claim 1 wherein the associated input parameters are geometric parameters corresponding to the path of the robot, parameters are selected from the group comprising goal configurations and geometry of a part being operated on by the robot.

6. The method according to claim 5 wherein the geometric parameters are selected from the group comprising goal configurations and geometry of a part being operated on by the robot.

7. The method according to claim 1 wherein the pre-defined attributes are selected from a group comprising a total cost value, a total cycle time, a total joint motion of the robot and a smoothness criterion for the allowed cyclic path.

8. A method for multi-goal path planning for a welding robot, said method comprising:
obtaining parameters associated with each goal of the multi-goal path;
identifying one or more allowed cyclic paths based on the obtained parameters by using inverse kinematics;
measuring values of pre-defined attributes of path segments for each of the one or more allowed cyclic paths wherein the values are measured by moving the welding robot along the each allowed cyclic path;
assigning weights to the pre-defined attributes;
calculating a cumulative score for each allowed cyclic path based on the values and the assigned weights of the predefined attributes; and
identifying an optimal path based on the cumulative score.

9. The method according to claim 8 wherein the welding robot is used in automotive manufacturing process for welding a body in white.

10. The method according to claim 8 wherein the associated input parameters are geometric parameters corresponding to the path of the welding robot.

11. The method according to claim 10 wherein the geometric parameters are selected from the group comprising goal configurations and geometry of a part being operated on by the robot.

12. The method according to claim 10 wherein the goal point configurations are selected from a group comprising position of the weld points and the weld gun orientation at the welding points.

13. A system for multi-goal path planning of a robot, said system comprising:
means for obtaining inputs regarding parameters associated with each goal of the multi-goal path;
means for identifying one or more allowed cyclic paths based on the obtained parameters; and
means for calculating a cumulative score for each of the one or more allowed cyclic paths based on values and assigned weights of pre-defined attributes for path-segments of each allowed cyclic path, wherein an optimal path is identified based on the cumulative score.

14. The system according to claim 13 wherein the robot is a welding robot.

15. The system according to claim 14 wherein the welding robot is used in automotive manufacturing process for welding a body in white.

16. The system according to claim 13 wherein the goal points are welding points.

17. The system according to claim 13 wherein the associated input parameters are geometric parameters corresponding to the path of the robot.

18. The system according to claim 17 wherein the geometric parameters are selected from the group comprising goal configurations and geometry of a part being operated on by the robot.

19. The system according to claim 13 wherein the pre-defined attributes are selected from a group comprising a total cost value, a total cycle time, a total joint motion of the robot and a smoothness criterion for the allowed cyclic path.
